(19) United States
(12) Patent Application Publication
(10) Pub. No.: US 2012/0194100 A1
(43) Pub. Date: Aug. 2, 2012

(54) LIGHTING DEVICE AND LUMINAIRE

(75) Inventors: Naoko IWAI, Yokosuka-shi (JP); Satoshi Watanabe, Yokosuke-shi (JP); Masanao Hieda, Yokosuka-shi (JP); Hiroshi Terasaka, Yokosuka-shi (JP); Yosuke Saito, Yokosuka-shi (JP)

(73) Assignee: Toshiba Lighting & Technology Corporation, Yokosuka-shi (JP)

(21) Appl. No.: 13/361,810

(22) Filed: Jan. 30, 2012

(30) Foreign Application Priority Data
Jan. 31, 2011 (JP) 2011-018792

(51) Int. Cl. H05B 37/02

(52) U.S. Cl. 315/307

(57) ABSTRACT

According to one embodiment, a lighting device includes a lighting circuit, a lighting time measuring circuit, an initial illuminance correction control circuit and a dimming control circuit. The lighting circuit lights an illumination lamp. The lighting time measuring circuit counts a lighting time of the illumination lamp. The initial illuminance correction control circuit performs initial illuminance correction control of the lighting circuit according to the lighting time counted by the lighting time measuring circuit, and controls light output of the illumination lamp to be constant during life of the illumination lamp. The dimming control circuit performs dimming lighting control of the lighting circuit according to a dimming signal.

### INCORPORATION BY REFERENCE

The present invention claims priority under 35 U.S.C. §119 to Japanese Patent Application No. 2011-018792 filed on Jan. 31, 2011. The content of the application is incorporated herein by reference in their entirety.

### FIELD

Embodiments described herein relate generally to a lighting device including a lighting circuit to light an illumination lamp and a luminaire.

### BACKGROUND

In general, the light intensity of an illumination lamp is highest at the time of start of use, and the light intensity is gradually reduced with the lapse of lighting time, and becomes lowest at the time of end of life. Then, if the light intensity is adjusted to that at the time of end of life, the light intensity of the illumination lamp during use can be kept constant from the time of start of use to the end of life. Besides, if dimming lighting control is performed so as to keep the constant light intensity from the time of start of use, energy saving is achieved. Hitherto, such a control is called initial illuminance correction control, and is adopted mainly in business luminaires using fluorescent lamps. The average life of the fluorescent lamp is 12000 hours, and the initial illuminance correction control is usually performed while the initial illuminance is made 70%.

Recently, an LED light source becomes popular as an energy saving light source, and in this case, the average life is 40000 hours, and the initial illuminance correction control can be performed while the light intensity is suppressed to 77% of the initial illuminance during the life.

On the other hand, in addition to the initial illuminance correction control, when natural light can be used in the daytime or the like, if the light intensity of the luminaire can be further reduced by the dimming lighting control, further energy saving is achieved.

However, in related art, even if the initial illuminance correction control and the dimming light control can be selectively selected, since the control becomes complicated, it is difficult to realize both the initial illuminance correction control and the dimming lighting control.

An object of an exemplary embodiment is to provide a lighting device having initial illuminance correction control and dimming lighting control and a luminaire.

### BRIEF DESCRIPTION OF THE DRAWINGS

FIG. 1 is a circuit block diagram showing a lighting device and a luminaire of a first embodiment.

FIG. 2 is a graph for explaining initial illuminance correction control of the lighting device and the luminaire.

FIG. 3 is a graph showing a relation between dimming signal and light intensity of the lighting device and the luminaire.

FIG. 4 is a graph showing a relation between dimming signal and light intensity of a lighting device and a luminaire of a second embodiment.

FIG. 5 is a graph showing a relation between dimming signal and light intensity of a lighting device and a luminaire of a third embodiment.

### DETAILED DESCRIPTION

In general, according to one embodiment, a lighting device includes a lighting circuit, a lighting time measuring circuit, an initial illuminance correction control circuit and a dimming control circuit. The lighting circuit lights an illumination lamp. The lighting time measuring circuit counts a lighting time of the illumination lamp. The initial illuminance correction control circuit performs initial illuminance correction control of the lighting circuit according to the lighting time counted by the lighting time measuring circuit, and controls light output of the illumination lamp to be constant during life of the illumination lamp. The dimming control circuit performs dimming lighting control of the lighting circuit according to a dimming signal.

There is an effect of providing a luminaire in which energy saving by the dimming lighting control is added to energy saving by the initial illuminance correction control, and further energy saving can be realized.

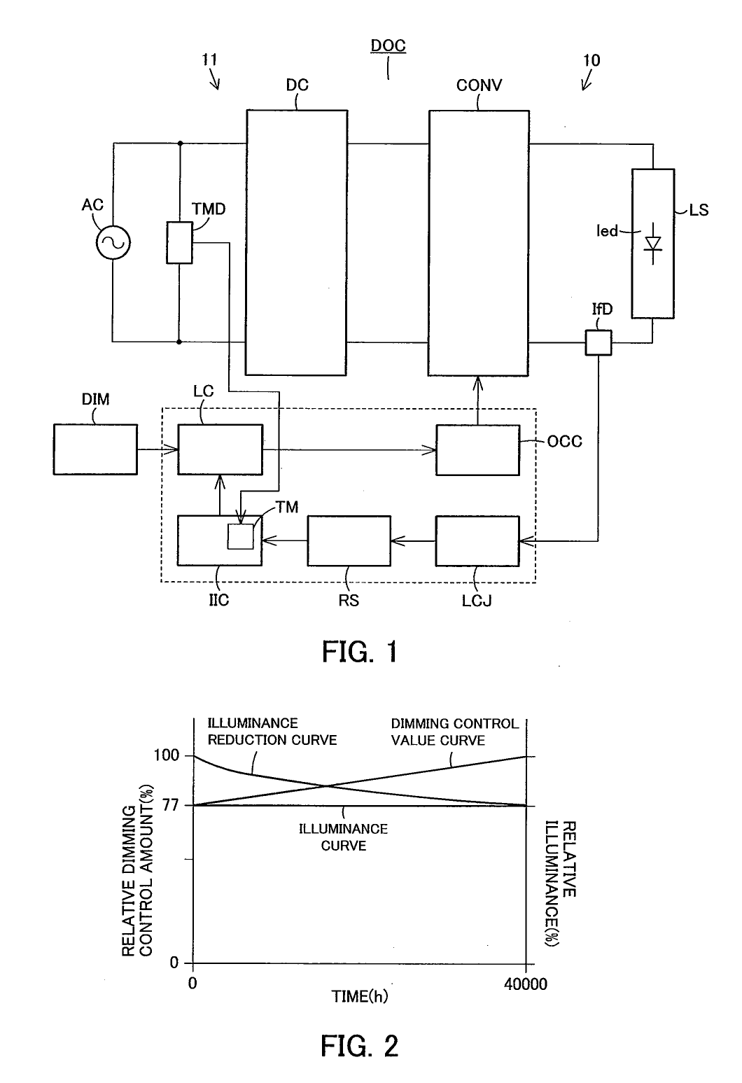

Next, a first embodiment will be described with reference to FIG. 1 to FIG. 3.

FIG. 1 is a circuit block diagram of the whole luminaire, and a luminaire 10 includes an illumination lamp LS as a light source and a lighting device 11. The lighting device 11 includes a lighting circuit DOC to light the illumination lamp LS, an initial illuminance correction control circuit IIC, a dimming control circuit DIM, a linkage control circuit LC, an output control circuit OCC and a timer drive circuit TMD.

First, the illumination lamp LS will be described. Although the illumination lamp LS may be any light source, for example, an LED illumination lamp or a fluorescent lamp can be used. The light source of the illumination lamp LS is not limited to the LED, and may be an electro-luminescence (EL), an organic light-emitting diode (OLED), an organic electro-luminescence (OEL) or the like. Incidentally, the illumination lamp LS of the embodiment is the lamp including the LED as the light source. When the LED is used as the light source of the illumination lamp LS, as is understood from a graph of FIG. 2, there are merits that the life is generally 40000 hours and is significantly longer than 12000 hours of the fluorescent lamp, and a light flux reduction at the end of life is about 77%, and the light flux reduction during life is small as compared with about 70% of the fluorescent lamp.

Accordingly, the LED lamp is subjected to the initial illuminance correction control, and the illuminance is made constant at 77% as indicated by an illuminance curve, so that energy saving can be realized. Incidentally, in order to make the illuminance constant during the life, a dimming control amount has only to be gradually changed to 100% as indicated by a dimming control value curve in the drawing according to the lighting time.

Besides, when the illumination lamp LS is constructed by using LEDs in the inside, the number of used LEDs led is not specifically limited. Plural LEDs led may be provided in order to obtain a desired amount of light. In this case, the plural LEDs led can form a series-connected circuit or a series-parallel circuit. However, the illumination lamp LS may include a single LED led.

Besides, the illumination lamp LS may include a power receiving end for connection with an output end of the lighting circuit DOC. Although the power receiving end has preferably a form of a cap, no limitation is made to this. Incidentally, as the cap, well-known various structures can be appropriately adopted. In brief, as long as a structure is for connection with the output end, the remainder of the structure is not specifically limited. For example, the power receiving end may have a form of a connector extended through a conductive wire from a main body of the illumination lamp LS. Besides, the power receiving end may be a connection conductor itself.

Further, the illumination lamp LS may have various forms. For example, the form may be a straight tube shape in which caps are provided at both ends, or a single cap shape, as in an incandescent lamp, in which a screw cap is provided at one end.

Further, a desired number of the illumination lamps LS can be connected in series to or in parallel to the lighting circuit DOC. Incidentally, if the parallel connection is performed, a constant-current circuit is preferably made to intervene so that load currents flowing through the respective parallel circuits are equalized.

Next, the lighting circuit DOC will be described. The lighting circuit DOC is a circuit to light the illumination lamp LS, and includes a direct-current power supply DC and a converter CONV. The lighting circuit DOC preferably includes, for example, a DC-DC converter as the converter CONV. The lighting circuit DOC includes an input end connected to an alternating-current power supply AC, and the output end to which the illumination lamp LS is connected. The lighting circuit supplies power to the illumination lamp LS through the output end, and lights the illumination lamp LS.

The output end of the lighting circuit DOC has only to be structured so as to be fitted with the power receiving end of the illumination lamp LS, and the remainder of the structure is not specifically limited. For example, although a form of a socket is preferable, if the power receiving end of the illumination lamp LS has a form of the connector, the output end may have a form of a connector receiver. Besides, if the power receiving end has a form of the connection conductor, the output end may have a form of a terminal stand to receive the connection conductor.

Besides, if the lighting circuit DOC includes the converter CONV and the direct-current power supply DC, as the converter CONV, for example, various choppers are preferable since the conversion efficiency is high and the control is easy. The converter CONV generally converts an input direct-current voltage into an alternating current or a direct current of a different voltage. The output voltage is applied to the illumination lamp LS. The illumination lamp LS can also be subjected to the dimming lighting control and lit to a desired level by controlling the output of the converter CONV and adjusting the output.

If the lighting circuit DOC is mainly composed of the converter CONV, the direct-current power supply DC and the converter CONV can be arranged in one-to-one correspondence. Besides, the direct-current power supply DC is made common, plural converters CONV are provided in one-to-plural correspondence, and the direct-current power supply DC may be supplied in parallel to the plural converters CONV. Incidentally, in the latter case, the respective converters CONV can be provided at positions adjacent to the illumination lamp LS by request, and the common direct-current power supply DC can be provided at a position separate from the illumination lamp LS.

Further, if the lighting circuit DOC lights the illumination lamp LS including the LED, the lighting circuit is constructed so that the output thereof is constant-current controlled. In this case, a composite control characteristic may be provided such that in a partial region, for example, in a region where the lighting power of the illumination lamp LS is low, in other words, in a deep dimming region, constant-voltage control is performed, and in the other region, the constant-current control is performed.

Further, in order to change the operation state of the illumination lamp LS, the lighting circuit DOC can be constructed such that the output of the lighting circuit DOC can be changed so as to change the power supplied to the illumination lamp LS according to an output control signal. That is, the illumination lamp LS can be subjected to the dimming lighting control according to a dimming signal and can be lit.

Although the converter CONV converts the direct-current input power supplied from the direct-current power supply DC, outputs a desired voltage, and lights the illumination lamp LS, the remainder of the structure is not specifically limited. Incidentally, if the converter is the DC-DC converter, the converter is a device to convert a direct-current power into a direct-current power of a different voltage, and is a conversion device also called a forward conversion device. The converter may be a flyback converter, a forward converter, a switching regulator or the like in addition to various choppers.

The structure of the direct-current power supply DC to supply an input to the converter CONV is not specifically limited. For example, the structure may be such that a rectifying circuit and a smoothing circuit are provided. As the smoothing circuit, an electrolytic capacitor can be used, or a booster chopper can be used. Incidentally, harmonics can also be effectively reduced by using the booster chopper.

Next, the initial illuminance correction control circuit IIC will be described. The initial illuminance correction control circuit IIC includes a lighting time measuring circuit TM and an illuminance correction device. The lighting time measuring circuit TM always measures the lighting time during lighting of the illumination lamp LS irrespective of whether the lighting control of the illumination lamp LS is the initial illuminance correction control or the dimming lighting control. That is, each time the illumination lamp LS is lit, the lighting time is measured, and the lighting time from the initial lighting is obtained by adding a new lighting time to an accumulated lighting time until the last lighting and extinction. The lighting time can be reset by a reset circuit RS when the used illumination lamp LS is replaced by a new one.

The illuminance correction device generates a dimming signal indicating, for a lighting time of the illumination lamp LS, a dimming degree required for illuminance to reach an initial illuminance control value previously set irrespective of whether the control is the initial illuminance correction control or the dimming lighting control. Incidentally, the lighting time measuring circuit TM and the illuminance correction device can be constructed of, for example, a microcomputer mainly including a timer, an arithmetic unit, a memory and a program. The arithmetic unit first reads the program from the memory, and next reads table data of dimming degree corresponding to the accumulated lighting time until the last time based on the read program, generates the dimming signal, and outputs the signal to the linkage control circuit LC. Besides, the accumulated lighting time until the last time is read, a new lighting time measured by the lighting time measuring circuit TM is added to this, updated lighting time data is stored in the memory, and preparation is made for next lighting. The memory previously stores the program and the table data including dimming degrees for respective accumulated lighting times, and stores the lighting time of the illumination lamp LS while updating the data each time. The program has the content of the above arithmetic procedure. Incidentally, the above structure is not limited to an individual one such as an IC, and the initial illuminance correction control circuit IIC can be constructed by using a timer, a memory and an arithmetic circuit of a microcomputer to control the whole luminaire.

Besides, the memory to store the lighting time data can be constructed of a main memory and a backup memory. By this, even if a lighting time timer of the main memory is erroneously reset, the lighting time can be restored by reading the lighting time data stored in the backup memory. Incidentally, although the backup memory can be set in the IC of the main memory or the microcomputer, a separate IC or microcomputer can also be used if necessary.

Next, the reset circuit RS will be described. The reset circuit RS can be provided by request. The reset circuit RS is a circuit for bringing the lighting time of the lighting time measuring circuit TM in the initial illuminance correction control into an initial state, that is, for initialization. When the illumination lamp LS is replaced by a new one, the lighting time of the initial illuminance correction control circuit IIC is reset and initialized, so that the initial illuminance correction control circuit TIC can again perform the initial illuminance correction control from the first. As the reset circuit RS, well-known various structures, such as an operation switch, a structure to respond to a non-load state detection circuit, and a structure to respond to the on and off of a power supply switch in a specified procedure, are suitably selected and adopted. However, the reset circuit RS can be replaced by the following structure by request, or one or two or more of the following structures can be added to the operation switch.

1. A structure is made such that a lamp mounting detection circuit is provided, and the lamp mounting detection circuit is repeatedly made to function a specified number of times so that the lighting time is reset. The lamp mounting detection circuit is originally a circuit adopted to protect the lighting circuit DOC from a high voltage by preventing the lighting circuit DOC from operating when the illumination lamp LS is not mounted, and may be the same circuit as a circuit to detect a non-load state.

2. A structure is made such that a built-in battery is used, and reset of the lighting time can be performed even in a cutoff state of the power supply of the luminaire 10. By this, the power supply is brought into the cutoff state, and the replacement of the illumination lamp LS is safely performed, and at the same time, the reset operation can be performed. Accordingly, the operation becomes easy.

3. A structure is made such that the reset circuit RS of the luminaire 10 under overall control of an external control device, which collectively controls plural luminaires 10, is made to reset the lighting time by remote control from the control device.

Next, a lamp replacement necessity determination circuit LCJ will be described. The lamp replacement necessity determination circuit LCJ can be provided by request. The lamp replacement necessity determination circuit LCJ detects an operation state of the illumination lamp LS at a normal time, and when a detection value deviates from a specified threshold range, a determination is made that the lamp replacement is required. The detection of the operation state may be electrical detection or optical detection. Incidentally, in this embodiment, a determination is made based on the change of a load current during the life inputted through, for example, a load current detection circuit IfD.

Next, the dimming control circuit DIM will be described. The dimming control circuit DIM is a circuit to perform the dimming lighting control of the illumination lamp LS at an arbitrary desired time differently from the case of the initial illuminance correction control. In this case, the dimming control circuit DIM generates a dimming signal, and controls the operation of the lighting circuit DOC through the linkage control circuit LC and the output control circuit OCC, so that the illuminance of lighting of the illumination lamp LS is changed. That is, the dimming control circuit DIM is a circuit to perform the dimming lighting control of the illumination lamp LS according to the dimming signal. Thus, the dimming control circuit DIM generates the dimming signal by an appropriate system, for example, a PWM modulation system. Besides, the dimming control circuit DIM may be independent of the luminaire 10 and disposed at a position separate from the luminaire 10, or may be incorporated in the luminaire 10.

The dimming signal sent from the dimming control circuit DIM to the output control circuit OCC is demodulated in the output control circuit OCC. Then, a drive signal outputted from a not-shown drive signal generation circuit in the converter CONV is intermitted according to the dimming degree. Incidentally, the dimming lighting control may be continuous dimming in which the light output of the illumination lamp LS is continuously changed or may be intermittent dimming in which the light output is stepwise changed.

Next, the linkage control circuit LC will be described. The linkage control circuit LC is a circuit to perform the linkage of the initial illuminance correction control circuit IIC and the dimming control circuit DIM when necessary, and causes the illumination lamp LS to be lit with a desired output characteristic. In the first embodiment, until the dimming degree of the dimming signal sent from the dimming control circuit DIM reaches 77% of the initial illuminance correction value, the dimming signal passes through the linkage control circuit LC and controls the output control circuit OCC. Besides, when the dimming degree is between 78% and 100%, the dimming degree for execution is not changed and is clipped to a constant of 77%.

In this embodiment, a structure in a range surrounded by a dotted line of FIG. 1 can be configured by a single microcomputer. In this case, the microcomputer can perform the control of the lighting circuit DOC, the initial illuminance correction control, the dimming lighting control and the linkage control of these in a collective manner.

Next, the timer drive circuit TMD will be described. The timer drive circuit TMD is a circuit to drive the lighting time measuring circuit TM. As long as the lighting time measuring circuit TM can be always driven during lighting of the illumination lamp LS irrespective of the type of the lighting control, the remainder of the structure is not specifically limited. For example, generally, there is no problem in that the illumination lamp LS is lit when the alternating-current power supply AC is applied to the lighting circuit DOC. Thus, the structure can be made such that the lighting time measuring circuit TM is driven when the alternating-current power supply AC is applied.

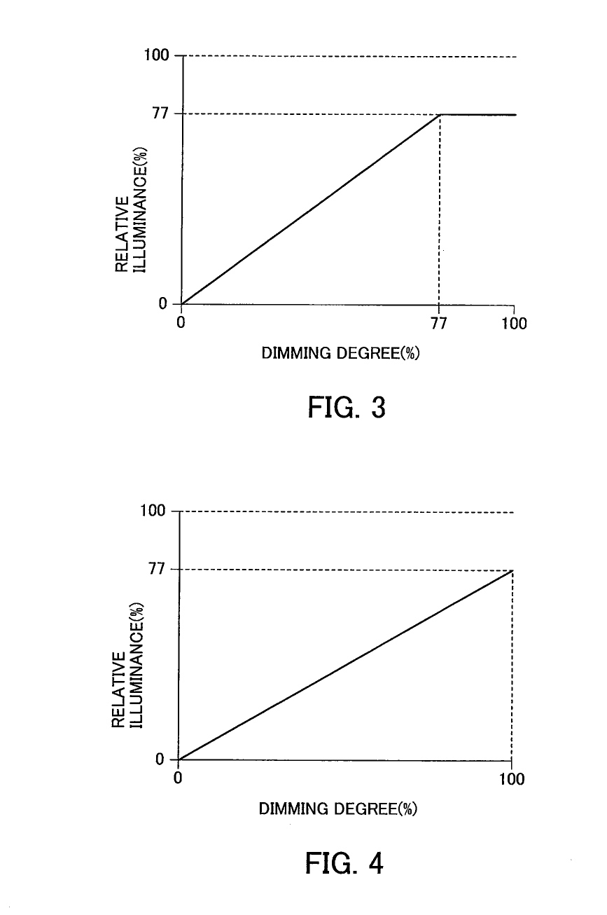

FIG. 3 shows a dimming characteristic of the dimming control circuit DIM in the first embodiment. That is, the controllable dimming degree is between 0% and 77%. Incidentally, in FIG. 3 to FIG. 5, the horizontal axis indicates the dimming degree (%), and the vertical axis indicates the relative illuminance (%).

According to the first embodiment, the relative illuminance of 77% is made the initial illuminance correction value, and the initial illuminance correction value is made the illuminance at the time of whole light lighting. Incidentally, as described above, the initial illuminance correction value changes with the lapse of lighting time. When the dimming degree is between 0% and 77%, the dimming lighting control can be arbitrarily performed according to the dimming signal, and also at the time of the dimming lighting control, the illumination lamp LS is lit at the illuminance not higher than the initial illuminance correction value. Accordingly, the user feels less uncomfortable. However, when the dimming degree is between 78 to 100%, the relative illuminance is controlled to be constant at the relative illuminance of 77% of the initial illuminance correction value.

Next, a second embodiment will be described with reference to FIG. 4.

A dimming characteristic in this embodiment is as shown in FIG. 4. That is, the relative illuminance of 77% is made the initial illuminance correction value, and between the dimming degree of 0% and 100%, the dimming lighting control can be arbitrarily performed according to a dimming signal while the relative illuminance is between 0% and 77%. Incidentally, as described above, the initial illuminance correction value changes with the lapse of lighting time. Thus, the linkage control circuit LC performs the initial illuminance correction control by the initial illuminance correction control circuit IIC and simultaneously performs the dimming lighting control in addition to this.

According to the second embodiment, the relative illuminance of 77% as the initial illuminance correction value is made the whole light lighting, and the continuous dimming lighting control can be performed in the range of the dimming degree of 0% to 100%, the user feels further less uncomfortable.

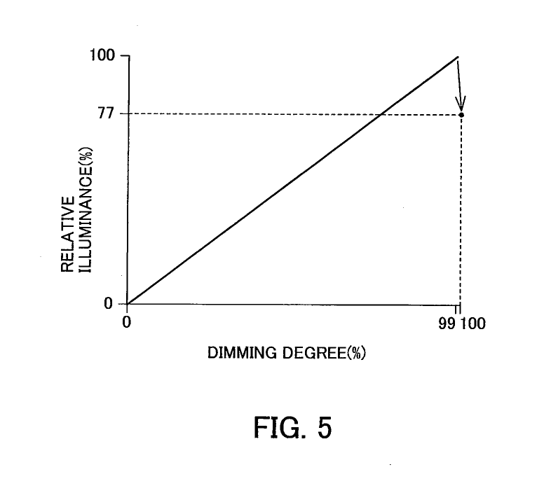

Next, a third embodiment will be described with reference to FIG. 5.

A dimming characteristic in this embodiment is as shown in FIG. 5. That is, between the dimming degree of 0% and 99% less than the maximum dimming degree, dimming can be performed between the relative illuminance of 0% and 99%. Thus, the linkage control circuit LC performs lighting control only by the dimming control circuit DIM in the range of the dimming degree of 0% to 99%, and does not perform the initial illuminance correction control by the initial illuminance correction control circuit IIC. Besides, at the maximum dimming degree of 100%, the lighting control is performed at the relative illuminance of 77% as the initial illuminance correction value.

According to the third embodiment, lighting in the high illuminance range of the relative illuminance of 77% to 99% exceeding the initial illuminance correction value by the initial illuminance correction control circuit IIC can be performed at the time of the dimming lighting control. That is, lighting in the high illuminance state can be performed, the illuminance range in which the dimming lighting control can be performed becomes wide, and various lighting can be performed. Besides, in the operation when the dimming signal is generated, since switching to the high illuminance lighting can be performed by, for example, varying an operation knob only by 1% from the dimming degree of 100% to 99%, the operation becomes easy.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A lighting device comprising:
a lighting circuit to light an illumination lamp;
a lighting time measuring circuit to count a lighting time of the illumination lamp;
an initial illuminance correction control circuit that performs initial illuminance correction control of the lighting circuit according to the lighting time counted by the lighting time measuring circuit, and controls light output of the illumination lamp to be constant during life of the illumination lamp; and
a dimming control circuit to perform dimming lighting control of the lighting circuit according to a dimming signal.

2. The device of claim 1, further comprising a linkage control circuit that performs the dimming lighting control by the dimming control circuit in a region where a dimming degree is equal to or less than an initial illuminance correction value of the initial illuminance correction control, and performs the initial illuminance correction control by the initial illuminance correction control circuit in a region where the dimming degree is equal to or more than the initial illuminance correction value of the initial illuminance correction control.

3. The device of claim 1, further comprising a linkage control circuit that performs the initial illuminance correction control by the initial illuminance correction control circuit and the dimming lighting control by the dimming control circuit, and performs lighting control with an initial illuminance correction value at a maximum dimming degree.

4. The device of claim 1, further comprising a linkage control circuit that performs the dimming lighting control by the dimming control circuit according to a dimming degree less than a maximum dimming degree, and performs the initial illuminance correction control by the initial illuminance correction control circuit at the maximum dimming degree.

5. The device of claim 1, wherein the lighting circuit includes a direct-current power supply to supply direct-current power, and a converter that converts the direct-current power supplied from the direct-current power supply and outputs the power to the illumination lamp, and the output of the converter is made variable by the initial illuminance correction control by the initial illuminance correction control circuit and the dimming lighting control by the dimming control circuit.

6. A luminaire comprising:
an illumination lamp; and
a lighting device of claim 1.

7. The luminaire of claim 6, wherein the illumination lamp is one of an LED, an EL, an organic light-emitting diode and an organic EL as a light source.
